(19) United States
(12) Patent Application Publication
(10) Pub. No.: US 2016/0059392 A1
(43) Pub. Date: Mar. 3, 2016

(54) UNIVERSAL SCREWDRIVER

(71) Applicant: NORTHEASTERN UNIVERSITY, Boston, MA (US)

(72) Inventors: Sean DeLaforcade, Montclair, NJ (US); Mary Katherine Farel, Jersey City, NJ (US); Matthew Jason Lapinski, Skillman, NJ (US); Joshua Peterson, Voorheesville, NY (US); Andrew Gouldstone, Dorchester, MA (US)

(21) Appl. No.: 14/784,930

(22) PCT Filed: Apr. 15, 2014
(86) PCT No.: PCT/US14/34159

§ 371 Date: Oct. 15, 2015

Related U.S. Application Data
(60) Provisional application No. 61/812,671, filed on Apr. 16, 2013.
(60) Provisional application No. 61/884,584, filed on Sep. 30, 2013.

(51) Int. Cl. B25B 15/02; B25B 15/00

(52) U.S. Cl. CPC B25B 15/02; B25B 15/005; B25B 15/007

(57) ABSTRACT

The present disclosure provides a screwdriver apparatus and method of making a screwdriver apparatus. The screwdriver apparatus includes a screwdriver head and an elastomeric flank coupled to the screwdriver head. The screwdriver head includes a base portion and an apex portion. The screwdriver head is wider at the base portion than at the apex portion in a first lateral plane. The elastomeric flank is positioned at least in part along a peripheral portion of the screwdriver head between the base portion and the apex portion of the screwdriver head.

### CROSS-REFERENCE TO RELATED APPLICATION

The present application claims priority to U.S. Provisional Patent Application No. 61/812,671, filed Apr. 16, 2013 and entitled “Universal Screwdriver,” and U.S. Provisional Patent Application No. 61/884,584, filed Sep. 30, 2013 and entitled “Universal Screwdriver,” which applications are incorporated herein by reference in their entireties.

### TECHNICAL FIELD

The present application relates generally to the field of tools. More specifically, the present application relates to tools and methods of making tools that may be implemented in the application or removal of rotatable fasteners such as screws.

### BACKGROUND

Screwdrivers use a method of mating surfaces between the driver and a screw head to apply torque to install and remove screws. While this method has been successfully implemented for screws and drivers with matching geometries, many goods and products are held together by a wide range of screw sizes with an equally wide range of screw head sizes and shapes or types. The variation in screw sizes and geometries generally warrants a host of distinct drivers to access a range of screw sizes and types.

### SUMMARY

The inventors have appreciated that a screwdriver apparatus may be provided that may be implemented with a variety of screw sizes and screw types. Accordingly various exemplary embodiments provide a screwdriver apparatus and method of making a screwdriver apparatus.

Various embodiments provide a screwdriver apparatus including a screwdriver head and an elastomeric flank coupled to the screwdriver head. The screwdriver head includes a base portion and an apex portion. The screwdriver head is wider at the base portion than at the apex portion in a first lateral plane. The elastomeric flank is positioned at least in part along a peripheral portion of the screwdriver head between the base portion and the apex portion of the screwdriver head.

In particular embodiments, the screwdriver head includes a geometric profile that is at least partially stepped from the base portion to the apex portion and that is bilaterally symmetric about a central longitudinal axis extending from the base portion to the apex portion. The geometric profile may include one or more sloped portions extending between one or more steps. The screwdriver head is tapered in a second lateral plane orthogonal to the first lateral plane, in accordance with particular embodiments. The elastomeric flank may be multi-faceted and may be positioned on a first side of the screwdriver head and a second side of the screwdriver head, the first side opposite the second side. In particular embodiments, the base portion is coupled to a hexagonal base. The base portion may be coupled to a cylindrical screwdriver shaft. The elastomeric flank extends through an aperture disposed in the screwdriver head, in accordance with particular embodiments. The elastomeric flank may be coupled to the screwdriver head by an adhesive. In particular embodiments, the elastomeric flank includes rubber. In particular embodiments, the elastomeric flank includes polyurethane. The polyurethane may have a durometer of 80 A to 90 A. In particular embodiments, the screwdriver head includes stainless steel. The peripheral portion may include a first side of the screwdriver head and a second side of the screwdriver head opposite the first side. In particular embodiments, the elastomeric flank is disposed on the first side and the second side. The first side may lie in a first plane and the second side may lie in a second plane where the first plane is coplanar with the second plane coplanar. The first side may lie in a first plane and the second side may lie in a second plane where the first plane and the second plane converge from the base portion to the apex portion. In particular embodiments, the apex includes a pointed tip. In particular embodiments, the apex includes a flat tip. In particular embodiments, the apex includes a rounded tip.

Various embodiments provide a method of manufacturing a screwdriver apparatus. The method includes forming a metal plate into a screwdriver head having a base portion and an apex portion. The metal plate is formed such that the screwdriver head is wider at the base portion than at the apex portion in a first lateral plane of the screwdriver head. The method also includes coupling an elastomeric flank to the screwdriver head at least in part along a peripheral portion of the screwdriver head between the base portion and the apex portion of the screwdriver head.

In particular embodiments, forming the metal plate includes cutting the metal plate such that the screwdriver head has a geometric profile that is at least partially stepped from the base portion to the apex portion and that is bilaterally symmetric about a central longitudinal axis extending from the base portion to the apex portion. The method also includes cutting the metal plate such that the geometric profile includes one or more sloped portions extending between one or more steps, in accordance with particular embodiments. Forming the metal plate may include laser cutting. Coupling the elastomeric flank to the screwdriver head includes casting the elastomeric flank about the screwdriver head casting, in accordance with particular embodiments. In particular embodiments, casting includes causing the elastomeric flank to flow through an aperture disposed in the screwdriver head.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1A-1D illustrate front and side views of a screwdriver apparatus in accordance with exemplary inventive embodiments.

FIGS. 2A and 2B depict a screwdriver head having variable thickness and a sloped and stepped geometric profile in accordance with various exemplary inventive embodiments.

FIG. 3 provides a perspective view of a screwdriver apparatus in accordance with various exemplary inventive embodiments.

FIG. 4 shows a screwdriver apparatus including a hexagonal base in accordance with various exemplary inventive embodiments.

FIG. 5 shows a screwdriver apparatus including a screwdriver shaft and handle in accordance with various exemplary inventive embodiments.

FIG. 6 is a side view of a stepped geometric profile of a screwdriver head in accordance with various exemplary inventive embodiments.

FIGS. 7A-7C illustrates side views of a plurality of geometric profiles of screwdriver heads in accordance with various exemplary inventive embodiments.

FIG. 8 provides a superimposed depiction of a Philips, torx, flat, and hex screws of the same size.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive screwdriver apparatuses and methods of manufacturing screwdriver apparatuses. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

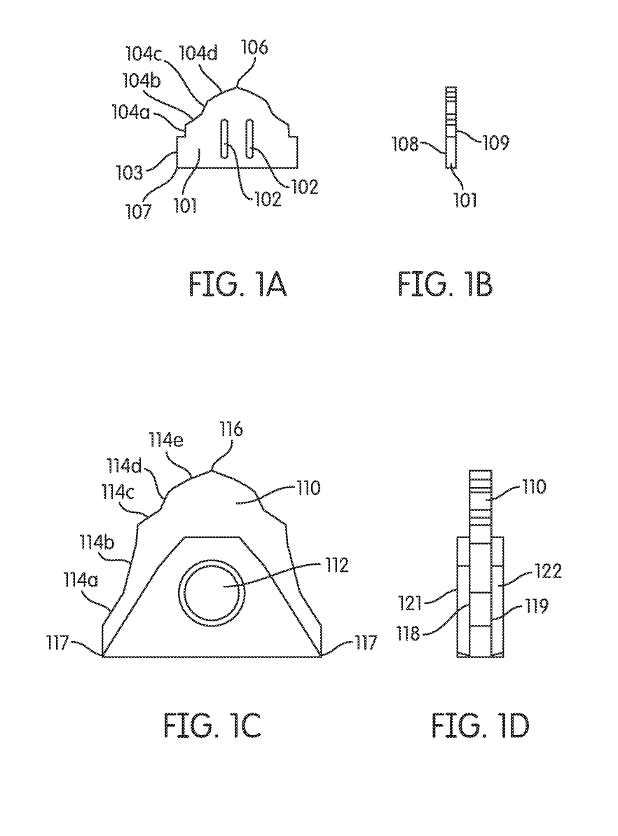

FIGS. 1A-1D illustrate front and side views of a screwdriver apparatus in accordance with exemplary inventive embodiments. FIG. 1A illustrates a front view of a screwdriver head 101 according to a particular embodiment. FIG. 1B illustrates a side view of the screwdriver head 101. The screwdriver head 101 includes an apex portion 106 and a base portion 107. The screwdriver head 101 is wider at the base portion 107 than it is at the apex portion 106. The screwdriver head 101 is bilaterally symmetric about a central longitudinal axis 105 extending from the apex portion to the base portion 107. The screwdriver head 101 includes flow through apertures 102 for receiving an elastomeric material therethrough as will be discussed further herein. The screwdriver head 101 has a non-linear geometric profile that in the illustrated embodiment is partially stepped and partially sloped. More specifically, the screwdriver head 101 includes stepped portions 103 and sloped portions 104a-104d. The stepped portions 103 and the sloped portion 104a-104d extend between a plurality of inflection points to form the geometric profile of the screwdriver head 101. As illustrated in FIG. 1B, the screwdriver head 101 may be flat in example embodiments, such that a first side 108 of the screwdriver head 101 and a second side 109 of the screwdriver head 101 are coplanar with one another. In example embodiments, the screwdriver head 101 may be composed of a metal such as stainless steel, including, but not limited to, 31 to 24 gauge stainless steel. In example embodiments, the screwdriver head 101 may be composed of 304 stainless steel. The geometric profile of the screwdriver head 101 conforms to a variety of screws. In a particular embodiment, the geometric profile of the screwdriver head 101 fits ¼ inch hex screws ranging from size 0-20.

FIG. 1C illustrates a front view of a screwdriver head 111 according to a particular embodiments. FIG. 1D illustrates a side view of the screwdriver head 111, that is formed of a plurality of layers including a central plate 110 and reinforcement plates 121 and 122 disposed on a first side 118 and a second side 119, (coplanar with the first side 118 in the example embodiment) of the central layer 110. The reinforcement plates 121 and 122 are generally shorter than the central plate 110 so that the screwdriver head 111 is thinner near the tip, to fit smaller screws, and reinforced near the base for improved stiffness. The reinforcement plates 121 and 122 may be coupled to the central plate 110 via various methods including, but not limited to, laser welding. The reinforcement plates 121 and 122 may share all, some, or none of the geometric profile on the central plate 110. The central plate 110 may have a distinct thickness from reinforcement plates 121 and 122, in example embodiments. The central plate 110 of the screwdriver head 111 includes an apex portion 116 and a base portion 117. The screwdriver head 111 is wider at the base portion 117 than it is at the apex portion 116. The screwdriver head 111 is bilaterally symmetric about a central longitudinal axis 115 extending from the apex portion to the base portion 117. The screwdriver head 111 includes a single flow through aperture 112 for receiving an elastomeric material therethrough. The central plate 110 of the screwdriver head 111 also has a non-linear geometric profile that in the illustrated embodiment includes a plurality of sloped sections 114a-114e, sloped at different angles. The screwdriver head 111 includes one more distinct section than the screwdriver head 101.

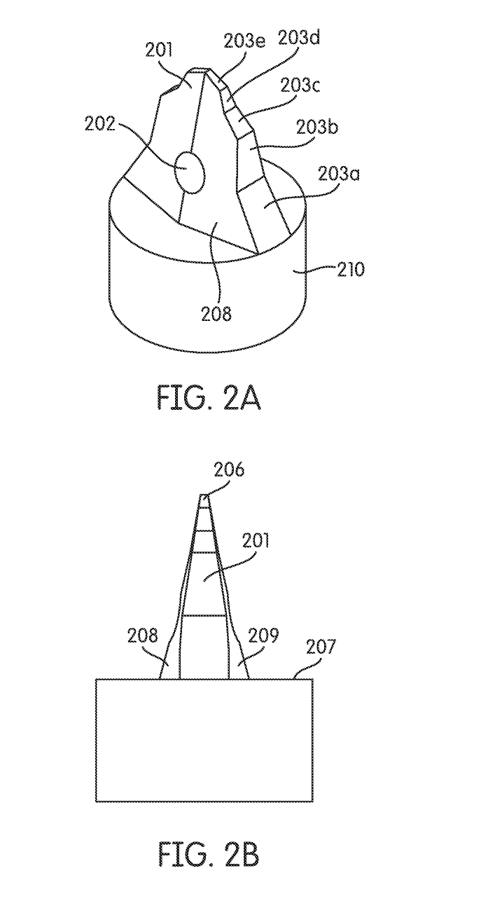

FIGS. 2A and 2B depict a screwdriver head having variable thickness and a sloped and stepped geometric profile in accordance with various exemplary inventive embodiments. The implementation of a variable-thickness plate helps reduce torsional deformation. FIG. 2A illustrates a perspective view of a screwdriver head 201 being tapered from an apex portion 206 to a base portion 207, such that the screwdriver head 201 has variable thickness as further illustrated in the side view shown by FIG. 2B. As viewable in FIG. 2B, a first side 208 lies in a first plane and a second side 209 lies in a second plane. The first plane and the second plane converge from the base portion 207 to the apex portion 206 so that the screwdriver head 201 has a variable thickness. As further shown in FIG. 2A, the screwdriver head 201 is also wider at a base portion 207 than at the apex portion 206 in a plane orthogonal to the plane of the side view shown in FIG. 2B (i.e. a plane into the page with respect to FIG. 2B) via the geometric profile composed of the sloped sections 203a-203e. The screwdriver head 201 is depicted still coupled to stock 210 from which the screwdriver head 201 is cut. The screwdriver head 201 may also include an aperture 202 configured to assist in coupling an elastomeric material including, but not limited to, a polyurethane, to the screwdriver head 201.

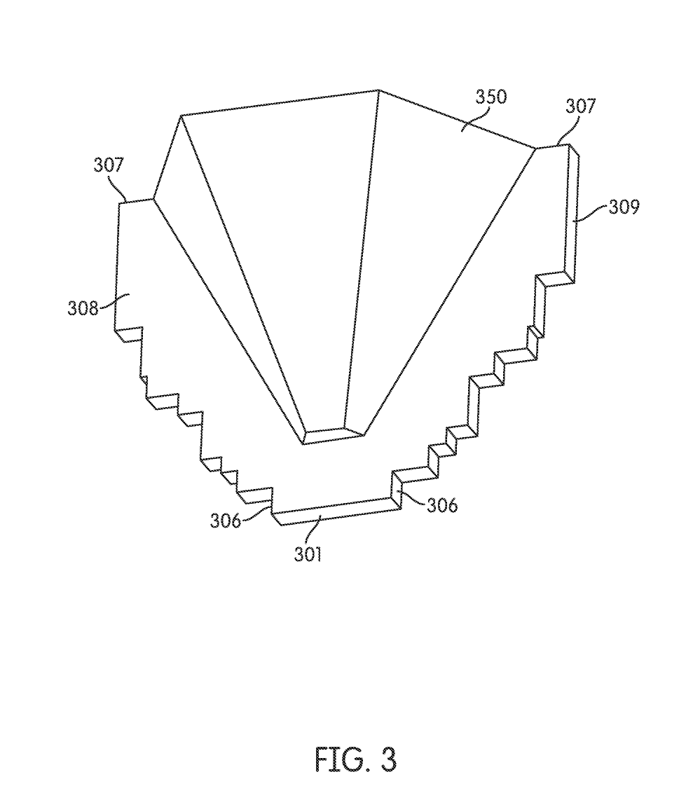

FIG. 3 provides a prospective view of a screwdriver apparatus in accordance with various exemplary inventive embodiments. Screwdriver head 301 includes an elastomeric flank 350 coupled thereto. The elastomer flank 350 may be faceted or formed with a plurality of distinct faces. The elastomeric flank 350 helps the screwdriver to mate with the recessed geometry of a range of screws through its compliance and elasticity. The screwdriver head 301 gives the screwdriver apparatus additional strength to apply the requisite torque for inserting and removing screws. The elastomeric flank 350 may be coupled to the screwdriver head 301 along a peripheral portion of the screwdriver head 301 including on a first side 308 and on an opposing second side 309 of the screwdriver head 301. The elastomeric flank 350 is positioned along at least a portion of the peripheral portion of the screwdriver head 301 between the base portion 307 and the apex portion 306 of the screwdriver head 301. The elastomeric flank 350 may extend to the base portion 307 and/or the apex portion 306 in various embodiments. The elastomeric flank 350 may include a rubber material, such as a polyurethane rubber in accordance with various embodiments. The elastomeric flank 350 may be coupled to the screwdriver head 301 via casting. For example, the elastomeric flank 350 may be heated and provided as a liquid that flows through an aperture in the screwdriver head 301 before hardening on opposing sides of the screwdriver head 301. The hardening may be facilitated via a mold, such as multi-cavity mold, provided about the screwdriver head 301 to maintain the liquid elastomeric material in a particular shape, such as the multifaceted shape illustrated in FIG. 3, until the elastomeric material cools and hardens. The elastomeric flank may be cast using two-part liquid compounds of 80 A durometer polyurethane in example embodiments. The elastomeric flank 350 may be coupled to the screwdriver head 301 via chemical bonding, such as via an adhesive or other bonding agent, in accordance with various embodiments.

The screwdriver head 301, like example embodiments 101, 111, and 201, includes a base portion 307 and an apex portion 306. The screwdriver head 301 is narrower at the apex portion 306 than at the base portion 307 along the first side 308 and along the coplanar second side 309. The screwdriver head 301 includes a stepped geometric profile, including steps 303a-303g. In one example embodiment, steps 303a -303g correspond to ¼ inch hex screw sizes 20, 10, 8, 6, 4, 2, and 0 respectively.

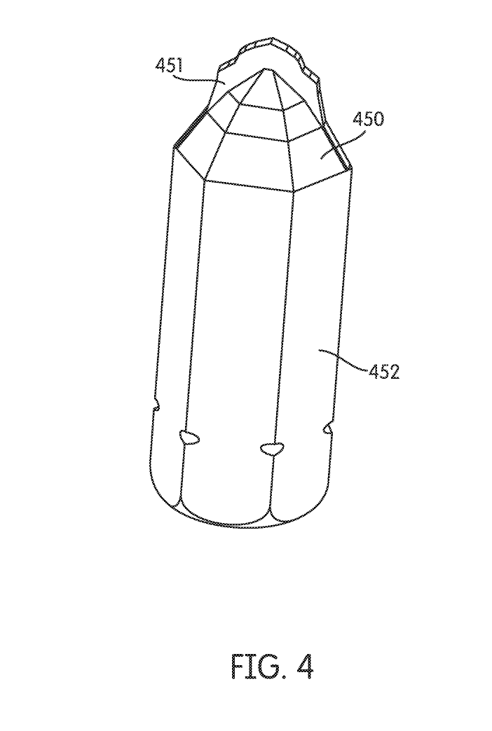

FIG. 4 shows a screwdriver apparatus including a hexagonal base in accordance with various exemplary inventive embodiments. A screwdriver head 451 in accordance with various exemplary embodiments disclosed herein, such as screwdriver heads 101, 111, 201, 301 (and other embodiments disclosed herein), may be coupled to an elastomeric flank 450 and may be coupled to a hexagonal base 452. Hexagonal base 452 may include, a ¼ inch hexagonal cylinder configured to fit in ¼ inch socket such as a screwdriver socket, a ratchet socket, or an adjustable drill, or drill-bit socket. In accordance with various embodiments, a screwdriver head 451 may be provided for suitable use with larger or smaller hexagonal bases.

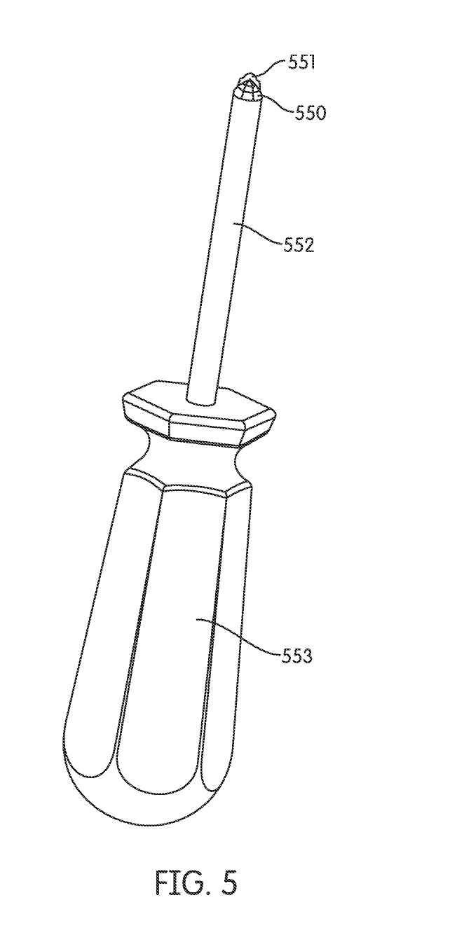

FIG. 5 shows a screwdriver apparatus including a screwdriver shaft and handle in accordance with various exemplary inventive embodiments. A screwdriver head 551 in accordance with various exemplary embodiments disclosed herein, such as screwdriver heads 101, 111, 201, 301 (and other embodiments disclosed herein), may be coupled to an elastomeric flank 550 and may be coupled, for example directly and integrally, with a cylindrical screwdriver shaft 552. The screwdriver shaft 552 may include a gripping handle 553 coupled thereto, for example at an opposing end of the screwdriver shaft 552.

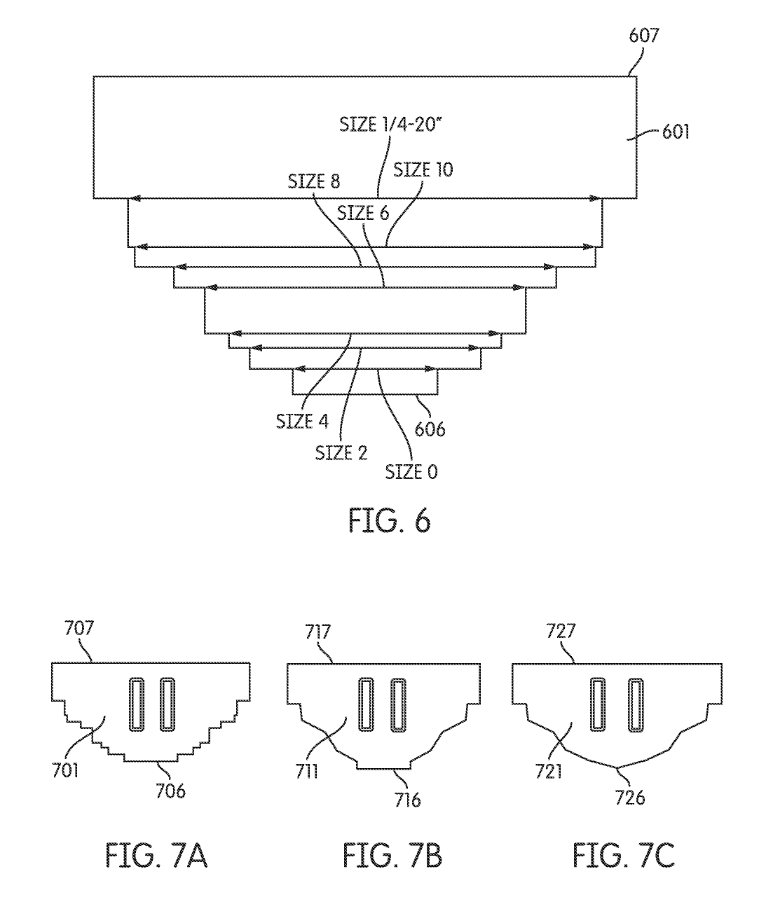

FIG. 6 is a side view of a stepped geometric profile of a screwdriver head in accordance with various exemplary inventive embodiments. Screwdriver head profile 601 includes a plurality of steps that facilitate forming a screwdriver head configured for use with ¼ inch size 0, 2, 4, 6, 8, 10 and 20 screws. Screwdriver head profile 601 facilitates forming a screwdriver head having a geometric profile that is wider at a base portion 607 than at an apex portion 606.

FIGS. 7A-7C illustrate side views of a plurality of geometric profiles of screwdriver heads in accordance with various exemplary inventive embodiments. Screwdriver head profiles 701, 711, and 721 may be formed by various modifications of profile 601, such as by forming a slope between various screw sizes on the stepped profile 601. As illustrated, screwdriver heads may have a completely stepped profile as shown by screwdriver head profile 701 or screwdriver heads may have a partially stepped and partially sloped profile as shown by screwdriver head profile 702. Screwdriver head profiles 701, 711, and 721 are wider at base portion 707, 717, and 727 than at apex portions 706, 716, and 726. As further illustrated in FIGS. 7A-7C, screwdriver heads in accordance with example embodiments may include a flat or plateau apex portion 706 or 716 and may include a pointed apex portion 726. In example embodiments, the apex portion may include a rounded apex portion.

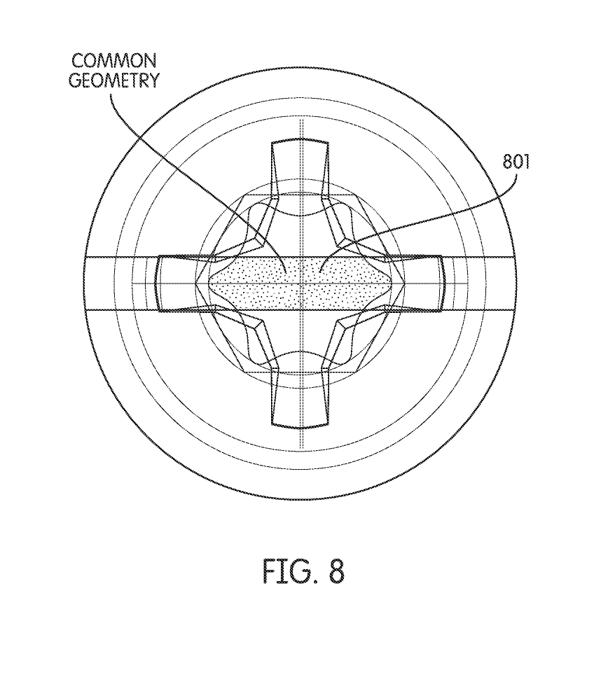

FIG. 8 provides a superimposed depiction of a Philips, torx, flat, and hex screws of the same size. The superimposition of these screws provides a common geometric profile 801. In accordance with example embodiments, geometric profile 801 may provide the shape of a peripheral portion of a screwdriver head between a base portion and an apex portion of the screwdriver head.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A screwdriver apparatus comprising:
a screwdriver head, the screwdriver head including a base portion and an apex portion, the screwdriver head wider at the base portion than at the apex portion in a first lateral plane; and
an elastomeric flank coupled to the screwdriver head, the elastomeric flank positioned at least in part along a peripheral portion of the screwdriver head between the base portion and the apex portion of the screwdriver head.

2. The screwdriver apparatus of claim 1, wherein the screwdriver head includes a geometric profile that is at least partially stepped from the base portion to the apex portion and that is bilaterally symmetric about a central longitudinal axis extending from the base portion to the apex portion.

3. The screwdriver apparatus of claim 2, wherein the geometric profile includes one or more sloped portions extending between one or more steps.

4. The screwdriver apparatus of claim 1, wherein the screwdriver head is tapered in a second lateral plane orthogonal to the first lateral plane.

5. The screwdriver apparatus of claim 1, wherein the elastomeric flank is multi-faceted and is positioned on a first side of the screwdriver head and a second side of the screwdriver head, the first side opposite the second side.

6. The screwdriver apparatus of claim 1, wherein the base portion is coupled to a hexagonal base.

7. The screwdriver apparatus of claim 1, wherein the base portion is coupled to a cylindrical screwdriver shaft.

8. The screwdriver apparatus of claim 1, wherein the elastomeric flank extends through an aperture disposed in the screwdriver head.

9-13. (canceled)

14. The screwdriver apparatus of claim 1, wherein the peripheral portion includes a first side of the screwdriver head and a second side of the screwdriver head opposite the first side.

15. The screwdriver apparatus of claim 14, wherein the elastomeric flank is disposed on the first side and the second side.

16. The screwdriver apparatus of claim 14, wherein the first side lies in a first plane and the second side lies in a second plane, the first plane coplanar with the second plane coplanar.

17. The screwdriver apparatus of claim 14, wherein the first side lies in a first plane and the second side lies in a second plane, the first plane and the second plane converging from the base portion to the apex portion.

18. The screwdriver apparatus of claim 1, wherein the apex includes a pointed tip.

19. The screwdriver apparatus of claim 1, wherein the apex includes a flat tip.

20. The screwdriver apparatus of claim 1, wherein the apex includes a rounded tip.

21. A method of manufacturing a screwdriver apparatus, the method comprising:
forming a metal plate into a screwdriver head having a base portion and an apex portion such that the screwdriver head is wider at the base portion than at the apex portion in a first lateral plane of the screwdriver head; and
coupling an elastomeric flank to the screwdriver head at least in part along a peripheral portion of the screwdriver head between the base portion and the apex portion of the screwdriver head.

22. The method of claim 21, wherein forming the metal plate further includes cutting the metal plate such that the screwdriver head has a geometric profile that is at least partially stepped from the base portion to the apex portion and that is bilaterally symmetric about a central longitudinal axis extending from the base portion to the apex portion.

23. The method of claim 21, further comprising cutting the metal plate such that the geometric profile includes one or more sloped portions extending between one or more steps.

24. (canceled)

25. The method of claim 21, wherein the coupling the elastomeric flank to the screwdriver head includes casting the elastomeric flank about the screwdriver head.

26. The method of claim 25, wherein casting includes causing the elastomeric flank to flow through an aperture disposed in the screwdriver head.
